(19) United States
(12) Patent Application Publication
(10) Pub. No.: US 2024/0242106 A1
(43) Pub. Date: Jul. 18, 2024

(54) MACHINE LEARNING RANK AND PREDICTION CALIBRATION

(71) Applicant: Google LLC, Mountain View, CA (US)

(72) Inventors: Gil Shamir, Sewickley, PA (US); Zhuoshu Li, Pittsburgh, PA (US)

(21) Appl. No.: 17/927,398

(22) PCT Filed: Sep. 23, 2022
(86) PCT No.: PCT/US2022/044482

§ 371 Date: Nov. 23, 2022

(30) Foreign Application Priority Data
Dec. 12, 2021 (IL) 288917

(51) Int. Cl. G06N 20/00

(52) U.S. Cl. CPC G06N 20/00

(57) ABSTRACT

Methods, systems, and apparatus, including computer programs encoded on a computer storage medium for training and using machine learning (ML) models. In one aspect, a method includes receiving a digital component request. A first ML model can output scores indicating a likelihood of a positive outcome for digital components. Input data can be provided to a second ML model and can include feature values for a subset of digital components that were selected based on the output scores. The second ML model can be trained to output an engagement predictions and/or ranking of digital components based at least in part on feature values of digital components that will be provided together as recommendations, and can produce a second output that includes ranking and engagement predictions of the digital components in the subset of digital components. At least one digital component can be provided based on the second output.

### TECHNICAL FIELD

This specification relates to machine learning rank and prediction calibration for recommendation systems.

### BACKGROUND

Recommendation or user interaction rate (UIR) prediction models are commonly trained using logistic regression, minimizing logarithmic loss on predicted positive outcome or click probabilities. Such techniques can be used to predict the probability of a target variable, e.g., the probability that a recommendation will have a positive outcome.

### SUMMARY

In general, this specification describes systems, methods, and techniques for using machine learning calibration in recommendation machine learning models to capture the effects on the label outcome of an example induced by other examples that will be recommended together with the example. The techniques can be used for content-selection-process-based-recommendation (CSPBR) systems and other types of recommendation systems, particularly, but not limited to, recommendation systems in which there are two or more objectives to satisfy, improve, or optimize in the recommendations.

Improving the accuracy of rankings is important in recommendation systems. Recommendation systems can predict ratings or other scores for each item in a set of items based on one or more metrics related to the items, their intended use, past performance in that use, their users, and/or other information, and use those ratings/scores to provide recommendations. For example, given appropriate data about the effectiveness of components used together in a manufacturing process, a properly trained recommendation system can provide a ranked set of components that can be used to complete the process. Note that, in such cases, the selection of the components to use can be interdependent—that is, the selection of one component can influence the effectiveness of other selected components.

Using logistic regression to train recommendation machine learning models may not be optimal. Practical models can be misspecified, and credit attribution between features that are optimized to predict individual engagement rates may negatively affect ranking. Effects of features for which model designers have no access are thus marginalized, leading to predictions that are averaged over the training population, even if this population is heterogeneous.

An additional ranking loss that measures pairwise or listwise relationships among examples, e.g., items, recommended in response to the same request can partially disentangle this effect, specifically, pushing ranking related gradient updates only on to the model features that distinguish between the different examples in a co-recommended set—that is, examples that are recommended together—and not to the features that are common to all examples recommended together. This technique leverages misspecification due to improving ranking instead of improving per individual example prediction accuracy.

However, this approach still does not solve the primary misspecification problem: model features may not capture effects of one item over another. In addition, since at inference time there is a lack of knowledge of which items are co-recommended on the same request, the approach still does not aid in generating predictions that better model the behavior of a given item in the presence of the other items presented with the given item. Knowledge of these items is usually counterfactual, after predictions have already been made on the set of recommended items.

The rank and prediction calibration techniques described in this document can be used to improve recommendations related to interactive content. For example, when determining which items, e.g., digital components or search results, to recommend in conjunction with search results or other digital content, and in what position, the ranking of the candidate items can be more important (or just as important) than the actual score produced by a machine learning model used to predict the performance (e.g., interaction or engagement rate) of the item. The item ranked highest can be recommended for the most prominent position, and successively lower ranked items can be recommended for less prominent positions. Further, the ranking of an item can be influenced by the other recommended items.

Particular embodiments of the subject matter described in this specification can be implemented so as to realize one or more of the following advantages. The techniques described in this document can be used in a recommendation system to improve both rank and score items accuracy by allowing calibration to capture signals which are not captured by initial inference before co-recommended items are known, leading to more effective recommendations. Further, the techniques described in this document can be used to improve not only the rankings but also prediction accuracy of interaction or engagement probability for a set of components recommended together. In addition, the techniques can be used in cases where computing resources are limited by using a second, less resource intensive, calibration model when determining rankings among items initially selected by a first, more-resource intensive, machine learning model.

In addition, the calibration techniques described in this specification reduce distribution of co-displayed content that will not result in user engagement, thereby reducing wasted resources. The described techniques reduce the amount of resources expended distributing such content and more efficiently provide content across a network. In other words, the computing resources, such as network bandwidth, processor cycles, and/or allocated memory, are not wasted by using these resources to distribute content that should not be distributed or would not be consumed by the entity to which the content is distributed.

Further, the techniques described in this specification reduce the resources required to produce predictions. Specifically, a second calibration model that requires fewer computing resources, e.g., fewer processor cycles and/or less memory to store the model and/or intermediate values computed using the model, than a primary model is used to improve the predictions of the primary model. The calibration model can execute faster and use less memory as compared to running the primary model twice. The primary model can select a set of items to recommend without ranking the items, and the second, lighter-weight calibration model can run only on the selected items, and by using the knowledge of which items are selected, produce more accurate predictions, including the ranking of the items, than could be produced before the set of selected items was known. More accurate rankings can increase the likelihood that the user will engage with the selected items and/or enables the system to select a subset of selected items that, if provided, are more likely to be interacted with by the user.

One aspect features receiving a digital component request. First input data including feature values for features of each digital component in a set of digital components can be provided as input to a first machine learning model. The first input data can include feature values for features of each digital component in a set of digital components. The first machine learning model can be trained to output, for each digital component, a score that indicates a likelihood of a positive outcome for the digital component, wherein a positive outcome may indicate that a user interacted with, or is likely to interact with, the digital component when displayed on a device. The first input data can be processed using the first machine learning model. A first output of the first machine learning model can be received, and the first output can include respective scores for the digital components in the set of digital components. A second input data can include feature values for features of each digital component in a subset of digital components selected based on the respective scores for the digital components in the set of digital components. The second input data can be provided as input to a second machine learning model. The second machine learning model can be trained to output a ranking of digital components based at least in part on feature values of features of digital components that will be provided together as recommendations. The recommendations may be recommendations of digital components to be displayed on a device. The second input data can be processed using the second machine learning model. A second output of the second machine learning model can be received and include ranking of the digital components in the subset of digital components. At least one digital component in the subset of digital components can be provided based on the second ranking.

One or more of the following features can be included. The second machine learning model can be a same machine learning model as the first machine learning model. The second machine learning model can be a different machine learning model from the first machine learning model. The second machine learning model can be trained differently from the first machine learning model. The second machine learning model, when processing identical input as the first machine learning model, can execute fewer instructions to process the identical input than the first machine learning model. The second machine learning model can be trained on training examples that include features of a set of co-recommended digital components that have been provided together as recommendations.

A first plurality of training examples can be selected from among the training examples that include co-recommended digital components. One or more features in the first plurality of training examples can be modified, and modifying a feature in the one or more features can include removing information about co-recommended items. The first plurality of training examples can be added to the training examples.

The first machine learning model can produce a gradient, and the gradient can be propagated to a plurality of digital component embeddings. The digital component embedding can represent features of the co-recommend digital components. The first machine learning model can process an input that includes marginalized embeddings that represent a marginal contribution of a first feature over a contribution of a second feature and the second machine learning model processes an input that includes a plurality of digital component embeddings. The first machine learning model can be a neural network and the output of at least one layer of the neural network can be used to train the second machine learning model. The second machine learning model can be a neural network that can include a partial or full hidden layer that is configured to produce or use as input a third score associated with a first hidden digital component based on input associated with at least one second digital component. The third score can be a direct loss, a ranking loss or a similarity score and can be used as input to generate a prediction score of the second model.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment in which a recommendation system uses rank and prediction calibration to provide recommendations.

FIG. 2 illustrates a process for using rank and prediction calibration to provide recommendations.

FIG. 3 illustrates a training graph and deployment for a two pass inference model.

FIG. 4 illustrates ranking calibration with top layer embeddings.

FIG. 5. Illustrates ranking calibration with top layer embeddings similarity scores.

FIG. 6 illustrates ranking calibration with separate top layer embeddings.

FIG. 7 illustrates ranking calibration with separate top layer embeddings similarity scores.

FIG. 8 is a block diagram of an example computer system.

Like reference numbers and designations in the various drawings indicate like elements.

### DETAILED DESCRIPTION

The specification describes using machine learning calibration techniques that capture the effects on the label outcome—that is, the result produced by the machine learning model—of a given item that is induced by other items that will be recommended together with the given item. For example, if N items are to be recommended, then the recommendation of a first item (R₁) is influenced by the recommendation of other items (R₂ to R_{N}), and therefore the recommendation of R₁ should be calibrated against R₂ to R_{N}. In addition, calibration can improve the predicted rankings as well as engagement rates among the items (R₁ to R_{N}) in the set. A first machine learning model can be used to select the recommended items (that is, R₁ to R_{N}) and a second machine learning model can be used to calibrate the results of the first machine learning model. In some cases, a single machine learning model can be used as both the first and the second machine learning models, although the first and second machine learning models can be different machine learning models.

The approach described in this specification allows calibration to capture signals that cannot be captured by training on the individual examples without training directly on interactions between examples. Those captured signals are applied to improve prediction accuracy and to improve predictions of engagement rates and rankings among examples recommended together by a recommendation system.

The methods can be used in CSPBR systems configured to operate in situations where multiple items are recommended and the presence of one item can affect engagement with another item, including when there is a need during deployment to address the lack of knowledge of which items will co-recommend with the items for which a prediction is to be served. The techniques described in this specification include two-stage approaches. In a first stage, recommended items are selected individually, and in a second stage, predictions of engagement rates and ranking are adjusted to account for the co-recommended items. One example approach is a two-stage full inference method that, in the second stage, re-generates the predictions that include interactions with the complete model. Another example uses a smaller component calibration model in the second stage to adjust or refine the prediction in the first stage to one that accounts for the effects of the co-recommended items on the engagement rates of any particular item. In some implementations, the first stage merely selects a set of items without ranking the items, and the second stage ranks them.

The description that follows is largely in terms of UIR prediction systems, such as click-through rate or content selection systems, that predict the likelihood that a user or multiple users will interact with content, e.g., digital components. However, the approaches described in this document can be used to improve other types of recommendation and/or user engagement systems, as noted above.

Some UIR systems often have two or more objectives. A first objective can be used to generate accurate UIR predictions for specific items, e.g., specific digital components. Such predictions can be used for determining a value associated with digital components selected in a content selection process mechanism (e.g., a second ranked digital component's value). Another objective can be to produce accurate rankings among the items, which can allow for a more accurate selection of the subset of the items to be recommended, as well as more accurate ordering within this subset, such that the overall value is improved. For example, using accurate predictions enable the UIR system to place certain digital components in preferred positions, for example, positions that are more prominent within a user interface of a resource, e.g., of a web page or native application that includes multiple slots for displaying digital components to a user.

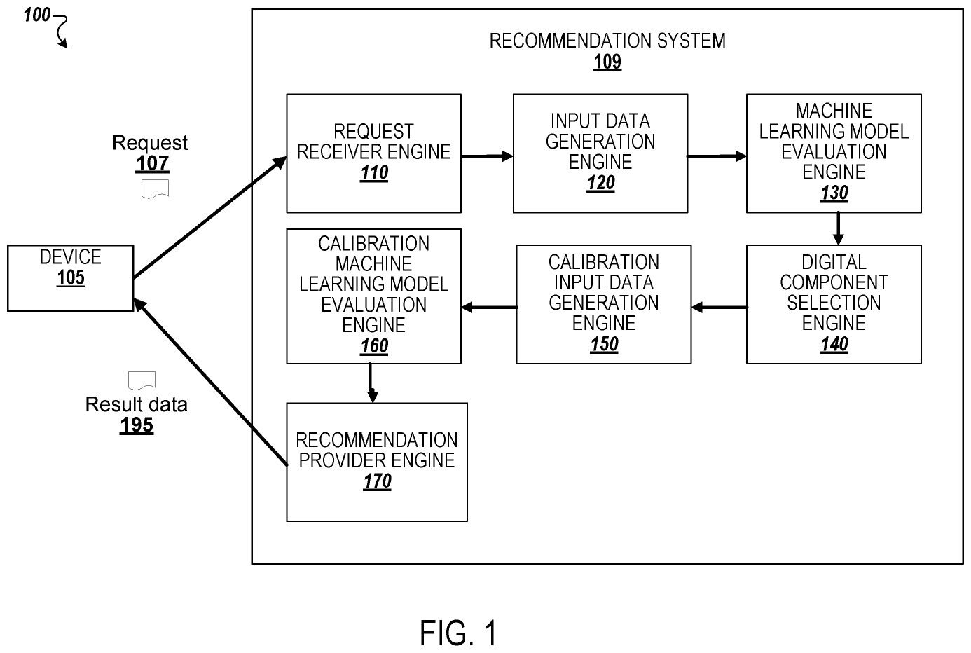

FIG. 1 illustrates an example environment 100 in which a recommendation system 109 uses rank and prediction calibration to provide recommendations. The recommendation system 109 can include a request receiver engine 110, an input data generation engine 120, a machine learning model evaluation engine 130, a digital component selection engine 140, a calibration input data generation engine 150, a calibration machine learning model evaluation engine 160 and a recommendation provider engine 170.

The recommendation system 109 can interact with one or more devices 105. In some implementations, the devices 105 include client devices, such as laptops, desktop computers, servers, mobile phones, tablet computers, smart speakers, gaming consoles, video streaming devices, etc. In some implementations, the devices 105 includes manufacturing devices, robots, machines, process controllers, inventory controllers, etc. The device 105 can provide a request for one or more recommended items, such as digital components or other items, such as parts or components used in manufacturing, processes used to diagnose and/or correct problems in a manufacturing facility, resources for which search results will be provided in response to a request, etc. Although the request 107 can be received from various types of devices and can be for various different types of items, the components of the recommendation system 109 are described in terms of digital components for brevity.

As used throughout this document, the phrase “digital component” refers to a discrete unit of digital content or digital information (e.g., a video clip, audio clip, multimedia clip, image, text or another unit of content). A digital component can electronically be stored in a physical memory device as a single file or in a collection of files, and digital components can take the form of video files, audio files, multimedia files, image files, or text files and may include advertising information, video recommendations and so on. For example, the digital component may be content that is intended to supplement content of a web page, application content (e.g., an application page), or other resource displayed by the application. More specifically, the digital component may include digital content that is relevant to the resource content, e.g., the digital component may relate to the same topic as the web page content, or to a related topic. The provision of digital components can thus supplement, and generally enhance, the web page or application content.

The request receiver engine 110 can receive a request 107 from a device 105. The request can be encoded in various formats. For example, the request can be included as parameters in a Hypertext Transfer Protocol (HTTP) or Hypertext Transfer Protocol Secure (HTTPS) request. The request can be included as parameters in a message, for example, encoded as a Simple Object Access Protocol (SOAP) or Representational State Transfer (REST). The request 107 can include data relevant to the request and data describing the request context, e.g., information about the device 105, such as the device type, language, location, display size, display resolution, etc. In some implementations, the request 107 can also include an identifier of the device 105 that transmitted the request. The data relevant to the request can be expressed as keywords, a full-text description, a Boolean search phrase, and so on.

The input data generation engine 120 can create input data using, for example the information included in the request 107 and/or additional information stored by the recommendation system 109. In addition, the input data generation engine can supplement the data included in the request 107, for example, by using a device identifier included in the request 107 to obtain descriptive information about the device 105 from which the request 107 was received. The input data generation engine 120 can produce input that is an embedded representation of the information included in the request 107 and supplemental information obtained, for example, from an external data store.

The machine learning model evaluation engine 130 can accept the input data produced by the input data generation engine 120 and process the input data using a first machine learning model that is trained to generate an output that includes, for each of multiple digital components in a list of components: (i) a first score that indicates a likelihood of a positive outcome, and (ii) a first ranking of the one or more components in a list of digital components. A positive outcome can indicate that a user interacted with, or is likely to interact with, the item. An example of a user interaction is a user selecting a digital component by clicking, tapping, providing voice input, and so on. The likelihood of a positive outcome can help to determine whether resources would be wasted if a particular digital component were to be recommended to be displayed but then not interacted with or utilized in some way. For example, network bandwidth, local processor computation and associated device and infrastructure resources such as memory allocation as well as centralized digital component publication resources would be wasted if a digital component were to be distributed and displayed but not interacted with by a user.

The machine learning model can be a neural network that has been trained on examples. Each example can include a set of feature values and an outcome. The outcome can be 1, indicating that a positive outcome occurred for the example, or a 0, indicating that a positive outcome did not occur for the example. Other values can be used to represent positive and negative outcomes.

The features can include keywords in the example 107 that indicate items, such as digital content, of interest, the context in which the request was generated, such as information being displayed when the request was sent, geographic location from which the request was sent, the type of device that sent the request, the language used on the device that sent the request, and so on. In addition, the features can include features of the items that can be recommended, such as features of movies or digital component creatives. For example, a movie might have a category (e.g., action, comedy, etc.), main performers, language, etc. and these can all be features for the movie. Further, features can include possible renderings of the recommendation such as a position in a list of recommended items.

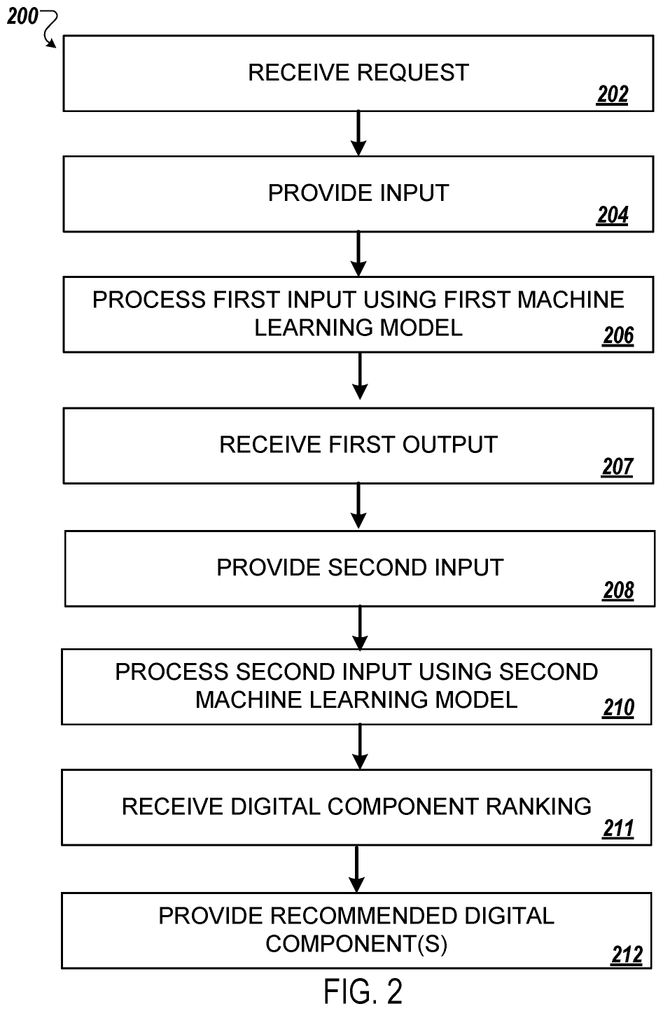

The digital component selection engine 140 can produce a set of selected items using the output from the machine learning model evaluation engine 130. The digital component selection engine 140 can select, for example, the digital components with the highest rankings, as described further with reference to FIG. 2. The set of selected digital components can include each selected digital component, the feature values associated with the digital component, and the output produced by the machine learning model evaluation engine 130.

The calibration input data generation engine 150 can create calibration input data using, for the digital components selected by the digital component selection engine 150, the information included in the request 107 and the output produced by the machine learning model evaluation engine 130. The calibration input data generation engine 150 can produce an input that is an embedded representation of this information, which can be numerical vectors that represent the feature values of the features.

The calibration machine learning model evaluation engine 160 can accept the input data produced by the calibration input data generation engine 150 and process the input data using a calibration machine learning model that is trained to generate an output that includes, for each of a plurality of digital components in a list of digital components selected by the digital component selection engine 140: (i) a calibrated score that indicates a likelihood of a positive outcome in the presence of the co-recommended items, and (ii) a calibrated ranking of the one or more components in a list of components and its predicted value in the presence of all other co-recommended items. As described above, a positive outcome can indicate that a user interacted with the item, for example, by selecting a digital component.

The calibration machine learning model 160 can be a neural network that has been trained on examples that include, for each example, a set of feature values associated with a set of features and an outcome. In some implementations, the calibration model 160 is an adjunct to the machine learning model described above and is not itself a complete model. The outcome can be 1, indicating that a positive outcome occurred for the example, or a 0, indicating that a positive outcome did not occur for the example. Other values can be used to represent positive and negative outcomes. The calibration machine learning model is described in more detail below.

In some implementations, the calibration machine learning model used by the calibration machine learning model evaluation engine 160 can be the same machine learning model as the one used by the machine learning model evaluation engine 130. In some implementations, the calibration machine learning model can be a different and a much simpler machine learning model, such as a machine learning model that is configured to complete using fewer computing resources, e.g., it can execute fewer instructions to process the identical input, than the machine learning model used by the machine learning model evaluation engine 130. The calibration machine learning model evaluation engine 160 can produce model output that can include, for each digital component, the digital component's ranking and predicted likelihood of a positive outcome.

The recommendation provider engine 170 can provide the result data 195 to the device. The result data can include one or more recommended items (e.g., items of digital content), and can include an indication of how the recommended items are ranked. For example, the items can be listed in the result data in ranked order, or they can have an associated ranking in the result data.

The recommendation provider engine 170 can provide the result data 195 using any appropriate communication method, such as providing them over HTTP, HTTPS, TCP/IP and so on.

FIG. 2 illustrates a process 200 for rank and prediction calibration. For convenience, the process 200 will be described as being performed by a system for rank and prediction calibration, e.g., the recommendation system 109 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

Although the example process 200 is described in terms of using machine learning models to select digital components as recommended items, the process 200 can also be used to generate and provide recommendations for other items, such as parts or components used in manufacturing, processes used to diagnose and/or correct problems in a manufacturing facility, resources for which search results will be provided in response to a request, etc., as described above.

In operation 202, the system receives a request. The system can receive the request using any appropriate technique, include using a networking protocol (e.g., Hypertext Transfer Protocol (HTTP), Hypertext Transfer Protocol Secure (HTTPS), etc.), through an application programming interface (API), etc. The request can be received from any entity interacting with the system such as a user or another system.

In operation 204, the system creates input data for a first machine learning model and provides the data to the first machine learning model. In some implementations, the system can create at least some of the input data by parsing the request to identify feature values for relevant features. Some features can be determined from the request, e.g., keywords, coarse geographic location of the requesting user, unigrams, a unique identifier for the requesting user, and so on. Some features can be relevant to the candidate items, such as movie category, topic of a digital component, format of the digital component, etc.

In some implementations, the model includes multiple stages, and in an intermediate stage, a set of candidate recommendations can be retrieved from a storage system (e.g., a relational database). The candidate recommendations can be scored by the machine learning model using the features described above.

The system can create the input from the features, for example by using a lookup table to map feature values for the features into numerical vectors that constitute the embeddings. The mapping values can be initialized to zero or to random values and learned as part of the training process for training the machine learning model.

In operation 206, the system processes a first input data using a first machine learning model that is trained to generate a first output that includes, for a set of digital components in a list of retrieved components: (i) a first score that indicates a likelihood that the component satisfies the request for the one or more components, and, optionally, (ii) a first ranking of the one or more components in a list of components. For example, for a digital component, the likelihood that the component satisfies the request can be the likelihood that a user will select the digital component. For a physical component, such as a tool, the likelihood can be the likelihood that the user uses the tool.

The machine learning model can evaluate, in addition to the features included in the input, input that describes features of the digital component, and features that describe the digital component and the request together.

The machine learning model can be any type of machine learning model configured to produce recommendations based on the input. For example, the machine learning model can be a neural network trained to produce recommendations based on request features, digital component features, features of the digital component together with the request, and features of the rendering system, e.g., the client device that will render the recommended item. The features of the rendering system can include, for example, the display position(s) on screen for the recommended item(s), user interface type in which the recommended item(s) will be presented, the format (e.g., image, video, audio, text, etc.) in which the recommended item(s) will be presented, etc. When the machine learning model is a neural network, the output of the machine learning model, or at least the output of one layer of the neural network, can be used to train a second machine learning model, as described further below.

The machine learning model can be trained using examples that include, for each example, the feature values related to a digital component, i.e., the feature values discussed in reference to operation 204. The output value in each training example can be an indication of whether the digital component was selected.

In operation 207, the system receives the first scores, and optionally, the first rankings. The system can receive the scores and rankings using various approaches. For example, the system can retrieve the scores and ranking by calling an API provided by the server running the machine learning model. In some implementations, the system and the machine learning model execute on the same computing device, and the system can receive the scores and rankings by directly accessing memory, e.g., by accessing a variable defined on the system or by accessing a memory location known to hold the scores and rankings.

In operation 208, the system provides a second input. The second input can include feature values for features of each digital component in a subset of digital components. The system can select the subset based on the respective scores for the digital components. For example, the system can select a number of digital components with the highest first scores produced in operation 206. In some implementations, the number of digital components selected is a pre-configured value used by the system. In some implementations, all digital components with scores above a configured threshold are selected for inclusion in the candidate set of digital components.

In operation 210, the system can process the second input using a second machine learning model that is trained to output a ranking of digital components based at least in part on feature values of features of digital components that are provided together as recommendations.

The second machine learning model can further output one or more scores. Scores can include, for example, a score that indicates the likelihood that a user will engage with a digital component and a score that indicates a loss (e.g., direct loss or a ranking loss) or a similarity score. The second machine learning model can be a neural network, such as a deep neural network. A deep neural network can include a partial or full hidden layer that produces a score associated with a first hidden component of the neural network based on input associated with at least one second component of the neural network. The score can be, for example, direct loss, a ranking loss or a similarity score as noted above.

In operation 210, the system processes the second input, which can be the same as the first input, using a second machine learning model (or “model” for brevity) that is trained to output a ranking of digital components based at least in part on feature values of features of digital components that will be provided together as recommendations.

In some implementations, the second input can further include additional features that were not used in the first stage. Such features can be related to, for example, the rendering system, such as the rendering format, positions, UI, etc. of the final recommendations. The second input can include the first input and the feature values related to the digital components in the candidate set of recommendations produced in operation 208. The second machine learning model can be the first machine learning model or a different machine learning model, as described below. The feature values related to the digital components in the candidate set of recommendations can include attributes such as size, shape, topic, color, producer of the component, etc.

The model may evaluate several categories of features including: (i) request only features, which are common to all examples recommended for a given request; (ii) digital component only features, which distinguish between the different examples, and have no information about the request that led to recommending digital component; (iii) digital component and request features (written “digital component x request” for brevity), which carry joint information about the request and the digital component recommend; and (iv) calibration features which can influence predictions based on other signals, such as the position of the recommend digital component within a user interface, digital component format, etc. The model can evaluate features in all such categories or a subset of the categories.

A wide range of features can be used in each feature category, and this specification lists only a subset as examples. Request-only features can include keywords in the request, the location from which the request was made, features of the requestor such as request history, and device used to make the request. Digital component only features can include physical characteristics of the digital component, such as size, shape and color, the producer of the component, a description of the component, etc. Digital component x request features can include features of the digital component considered jointly with features of the request. For example, a keyword included in a request can be considered with categories associated with a digital component; a category associated with the request can be considered jointly with a category associated with a digital item, a keyword associated with a request can be considered jointly with keywords (associated with the request and the digital component), and so on. Calibration features can include the type of user interface, the format of the digital component such as large or small, static or multimedia, image or text, color or black and white, position in which the digital component will be displayed, etc.

While such models can be trained to produce ranks and predictions using features that capture the interaction between a first digital component and a second digital component recommended together with the first digital component, exploiting this signal while performing inference can be complex. The complexity arises since, during the content selection process, knowledge of which digital components will be recommended together with a given digital component typically is not available, so this information cannot influence its prediction score, yet such a score is needed to determine which digital components to recommend or in which order to recommend the items. Thus, training usually commences on legacy examples for which logs contain the necessary information, allowing such signals to be used for training. However, the training should be applied so that it is useful when inferring UIR with this model. For this reason, executing the second machine learning model (which can be the same as the first machine learning model or different from the first machine learning model) is advantageous, where the first model selects the items without knowledge of which items are co-selected, and the second model refines the predictions and ranking within the selection with the knowledge of which items were co-selected together and having available one or more of the features of the item. Accordingly, the second model can be trained using training examples that can include features of a set of co-recommended digital components that have been provided together as recommendations.

Training the model for accuracy (e.g., with cross entropy logarithmic loss or other losses) can assign credit to request features, digital component features, and digital component x request features. Training the model for ranking (prediction or score difference) loss, in addition to the accuracy loss (which can be done by training on pairwise score differences in addition to cross entropy), can assign ranking credit to digital components and to digital components x request features and can avoid assigning credit to request only features, achieving better credit attribution between digital component (and digital component x request) related features and request features. The weight assigned by both mechanisms to a digital component can capture a marginalization—that is, a determination of the marginal contribution of a feature—on the effects of other digital components (for digital components features), and on the effects of other digital components for the particular request (for digital component x request features). Note that for a specific digital component on a specific request, the model weight learned for the crossed digital component x request may capture the average effect of all other digital components on this digital component with this request. For example, if all similar queries always show the same set of digital components, this result may be sufficient. However, if the digital component x request features in the model still marginalize on different populations of selections of other digital components in the request, this result may not be sufficiently accurate. For example, in a situation where a specific digital component may show with two or more sets of different digital components in response to the same request, features for the digital component and for the digital component x request will give a marginalized representation of all other digital components that are jointly recommended with this digital component, and with this digital component for this request, respectively. However, with knowledge of the other digital components, the marginalization can be disentangled, resulting in better predictions. Specifically, the system can select training examples from among the training examples that include co-recommended components, and for each selected training example, the system can add a training example that is identical to the training example, except that the newly added training example omits the information about co-recommended items. From these examples, the model learns a marginalization of the omitted information, and specifically, it learns a marginal contribution of a first feature over a contribution of a second feature. For examples for which this information is not omitted, the system learns the effect of the specified co-recommended items. Removing this information on a random or pseudorandom subset allows the model to be able to generate a prediction that marginalizes on the co-recommended items, which can be used in the first stage when these items are unknown. In addition, the first machine learning model can output a gradient, and the gradient can be propagated to some of the digital components in the embeddings. The digital component embedding can represent features of the co-recommend components.

To clarify the concept, consider an example in which: item A, when recommended with item B, has a positive outcome in 1000 out of 1000 examples, and item A when recommended with item C has 0 positive outcomes out of 1000 examples. Overall, on average, item A has 50% positive outcomes so with no additional information about co-recommended items, item A will have a predicted positive outcome rate of 50%. If 50% satisfies a recommendation threshold, item A can be recommended, but with modest confidence. However, if the system can determine that item A will be recommended with item B, then the predicted positive outcome rate will be 100%, item A should be recommended. Conversely, if the system can determine that item A will be recommended with item C, then the predicted positive outcome rate will be 0%, therefore item A should not be recommended.

Even when the model is able to predict what other digital components can be co-recommended with an individual digital component, the ability to produce such a prediction implies that if a different digital component is co-recommended with the model, the model would not be able to express a different effect on its recommendation. Therefore, such a solution may not be sufficient to provide sufficiently accurate predictions for recommendations.

Instead, calibration—that is, execution of a second machine learning model—is used in the process 200 between the prediction of the first machine learning model on a given digital component by the digital components which are co-recommended with the given digital component, and this process can be repeated for each recommended digital component. Given that the first machine learning model first selects which digital components to recommend without knowledge of which other digital components are recommended, an initial prediction can be generated that uses the marginalized information in the form of feature from the request, digital component, and digital component x request for this digital component. This initial prediction can be calibrated by the relation of this digital component to other digital components that are candidates for being recommended jointly with this digital component, which are now available to the system after the results of the first machine learning model are output.

The system can learn a representation (which can also be called an embedding) through direct loss (cross entropy or other) as well as ranking loss of the digital components. The representation can be learned, for example, as an embedding that is near the output of the deep neural network that is trained to make predictions about items. The system can use the representations in a calibration model. In some implementations, the calibration model can be used during a second pass on a full model if inference resources allow, as described below. In some implementations, the system can apply a calibration model to the prediction of the original pass. As discussed above, a reason for calibration can include, at time of retrieval, it is not known which other digital components will show in the request, but this information becomes available before the final prediction must be provided. The information can be provided to the model in a second stage, but if the second stage is resource limited, the system can use the information in a calibration model applied in addition to the original prediction.

In this approach, the model which is used to predict the label of the digital component of interest, denoted as DC1, and includes inputs representing the other digital components shown together with DC1. Such inputs can include embeddings, e.g., in an embedding vector, that represent features values of the other digital components, which can be a full hidden layer of the deep network used to predict the other digital components. In some implementations, the inputs can include a sum of the embeddings of the other digital components shown together with DC1. For example, the sum of the embeddings can be represented by an embedding vector. In some implementations, the inputs can include a vector of similarity scores between DC1 and each other digital component shown together with DC1. For example, if there are seven other digital components that have been shown together with DC1, this vector would include seven similarity scores, one for each of the seven other digital components. The similarity score for a digital component represents a measure of similarity between the features of DC1 and the digital component. The similarity score can be a correlation or cosine similarity, which are essentially a scalar product of the embedding vector for DC1 and the embedding vector for the digital component. Other similarity functions can also be used.

Training for DC1 with the effect of other digital components can commence by either applying updates to the embeddings representing other digital components from the losses of predicting the labels of DC1, or without applying such updates, where embeddings for the other digital components are only updated with the loss of predictions for these other digital components. The training can then be repeated for all digital components in the set of digital components.

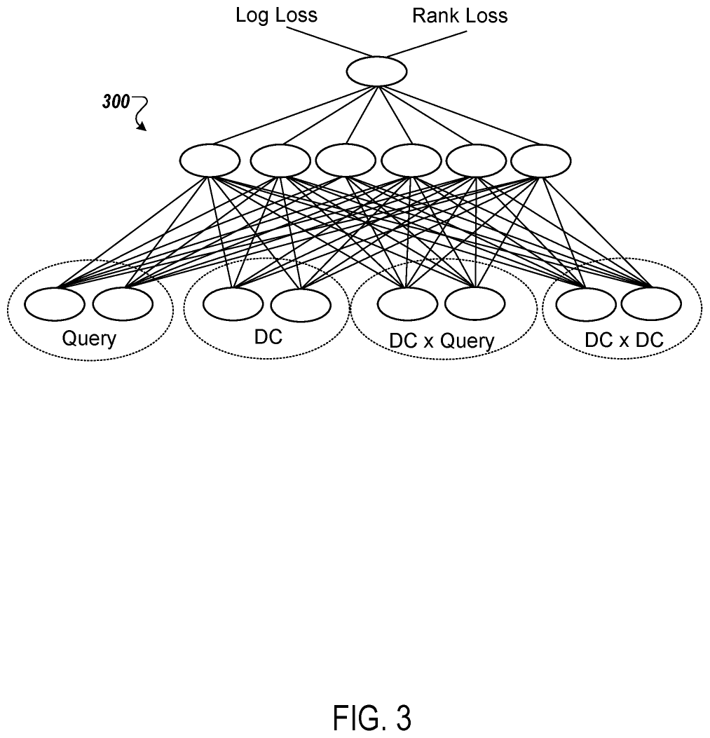

In some implementations, if the same model is used for both passes, in addition to learning the interaction with other digital components, the model can learn, for the first inference stage (retrieval and other initial prediction stages), to marginalize on all such digital components. Training can randomly drop out the scores produced from the other digital components for a fraction of examples, and replace them with a feature for DC1 that represents the marginalization of the score on all other co-displayed digital components. The dropped score can be replaced in the embedding of the inputs from the other digital components by using the marginalization embedding vector for examples that are randomly selected for at a fraction of training examples instead of their embeddings. This technique enables the model to learn (i) inferences when the other examples are known, and (ii) inferences when the other components are unknown. Case (ii) can be used in the first stage of model processing, and case (i) is used in the second stage once the other digital components are known. The embedding for case (ii) can be stored as a feature for DC1, representing the marginalization of all recommendations co-recommended with DC1. This embedding vector is trained with the model. The first inference stage uses this marginalized embedding vector as an input to determine an initial user interaction probability for the digital component. The second inference can use the embeddings (or a score based on the embeddings) of the other digital components co-recommended with DC1. This is illustrated in FIG. 3.

After selecting a set of eligible digital components that will show together with the digital component, another stage of forward propagation is applied to the model, where the forward propagation uses inputs that represent all other digital components in the set. Examples of either two-stage inference or calibration processes are described further in reference to FIGS. 3 through 7. The prediction generated in this pass is the final prediction for DC1.

In operation 211 the system receives from the second machine learning model the digital component rankings, and optionally, the scores for the digital components. As described above, the system can receive the scores and rankings using various approaches. For example, the system can retrieve the scores and ranking by calling an API provided by the server running the machine learning model. In some implementations, the system and the machine learning model execute on the same computing device, and the system can receive the scores and rankings by directly accessing memory, e.g., by accessing a variable defined on the system or by accessing a memory location known to hold the scores and rankings.

In operation 212, the system provides the recommended digital components. Recommendation can be provided using conventional data transmission techniques, such as sending the message over a networking protocol (e.g., HTTP or HTTPS) or as a return value for an API call.

An example of a two-stage inference system is illustrated in FIG. 3, which shows a training graph and deployment for a two-pass calibrated (primary) model. The model 300 can produce a prediction of the probability of a positive label representing the likelihood that a digital component will be interacted with, e.g., selected by a user based on accuracy and/or ranking loss.

Training for this model can use features randomly or pseudorandomly selected between the marginalization features and the features representing other digital components (when other digital components are used, backpropagation can be configured either to allow or to stop gradients from updating embeddings representing the other digital components). Inference can include two passes, one using marginalized features for other digital components, and one with actual features and/or embeddings of other digital components to set content selection parameters. In this case, the same model is used for both stages. More generally, inference can be performed using a primary machine learning model twice or using a primary and a calibration machine learning model, the primary model followed by a calibration model, as described below.

Two pass inference requires applying the full complexity of the complete model twice, first generating a prediction to preselected digital components, then refining the prediction with the knowledge of which components were preselected. In implementations where two-pass inference is impractical, for example, in cases in which the prediction at the first retrieval (digital component eligibility) phase is expensive, one-pass inference (of the primary model) can be used, followed by a pass using a less resource-intensive calibration model. The primary model can generate an initial prediction for DC1, independently of the other digital components selected with DC1 (i.e., implicitly marginalizing on these digital components). Training for the primary model can be independent of the other digital components—that is, the digital components that will be co-selected to appear with DC1—and inference can produce a prediction that is used for initial (eligibility) stages of determining which digital components to show for the request.

Next, a calibration model takes as input the prediction score for DC1 together with regular calibration features, and information about the other digital components shown together with DC1. In updates, gradients from the calibration model may optionally be applied to parameters of the primary model, stopping gradients from the calibration model to the primary model that produces the first prediction blocks updates from the calibration model to the primary model. Parameters in the calibration model, including other calibration features, can be updated as part of the calibration training stage. As described below, multiple implementations exist, each using different signals for calibration of co-recommended components.

Inference of a deployed model can require multiple steps. The prediction of the primary model can be used for selecting which digital components to select initially, and this prediction can be supplemented with other calibration features. Calibration in inference of the prediction for DC1 can be computed with knowledge of the other digital components. Specifically, if the system first selects all digital components to show, the system can use features representing the other digital components when evaluating the calibration model for DC1. If the system sequentially selects digital components (per position), first the top digital component to show, then the next one, until the final digital component is selected, the system can evaluate features from the previously selected digital components to calibrate the prediction for DC1. Marginalization features that are learned by the model can also be used, as described above, to represent digital components that have not yet been selected. However, this approach can, in some cases, weaken the results of disentangling the model from marginalizing on co-displayed digital components.

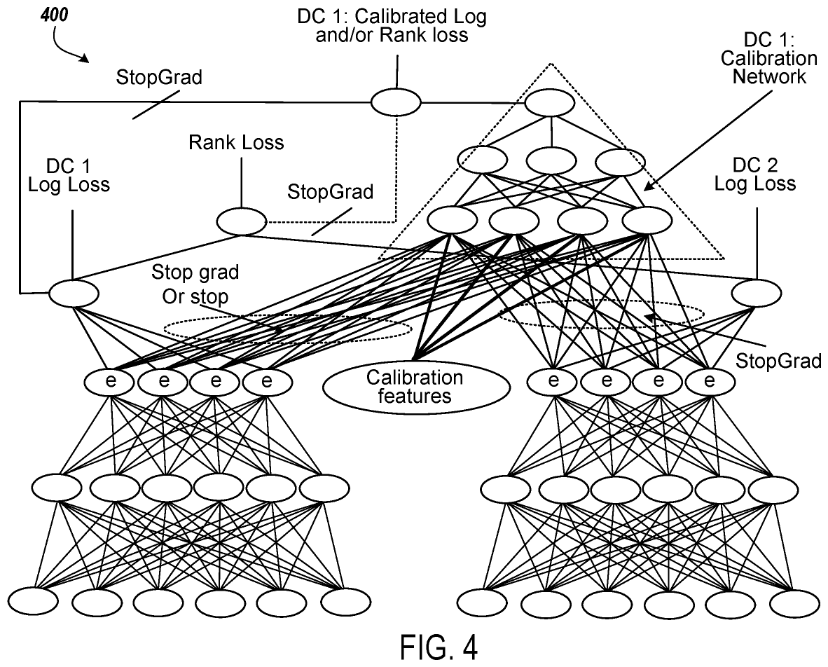

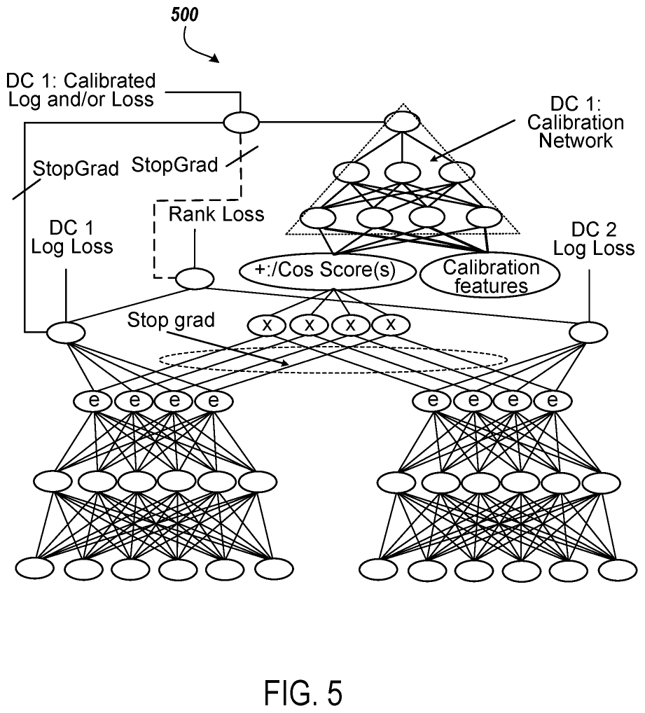

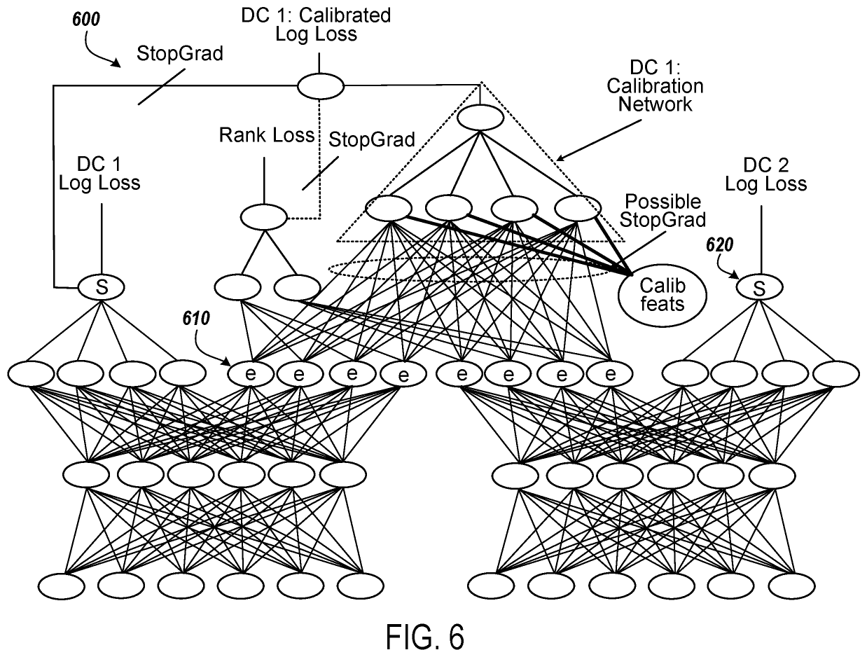

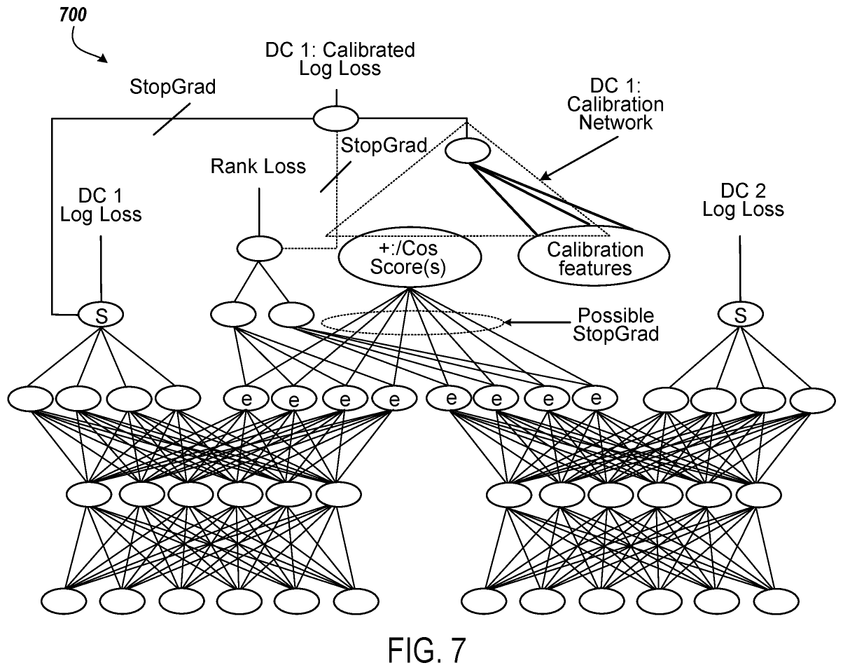

The approach described in this specification can train an embedding vector to represent each of the other digital components, and to use it for calibration of DC1. Multiple approaches can be used for training the embedding vector. First, the embedding can be the top layer (or another layer, or a component of that other layer) of the direct inference path of the other digital components (i.e., the top hidden layer of DC2 and all other digital components are used for calibrating DC1). This approach is illustrated in FIGS. 4 and 5, as described below. Gradient updates of the calibration on DC1 may optionally propagate to the primary prediction models for DC1 and/or DC2. Embeddings of DC1 and DC2 can be provided directly into the calibration model of DC1, which can take embeddings of all other digital components (DC3 and on) concatenated to those of DC2 (if there are a fixed number of digital components shown), or averaged or summed into one embedding vector input, as illustrated in FIG. 4. Note that average and summing involve fewer computing resources than concatenation, but can lose information, unlike concatenation. Instead of providing to the calibration model the embeddings of all digital components, the model can receive a similarity score (such as a simple dot-product, or cosine similarity) between the embeddings of DC1 and those of DC2, where such a score can be entered separately for each of the co-displayed digital components, or averaged over all co-displayed digital components, as illustrated in FIG. 5. A hidden vector, separate from the normal training loss can be used to generate the embeddings for ranking, as illustrated in FIGS. 6 and 7. This vector can be generated using a separate ranking loss, and can be fed directly into the calibration model (as illustrated in FIG. 6) or through a similarity score (as illustrated in FIG. 7). Gradients can also be propagated from the calibration model, but such propagation is not required.

The primary model can be trained for DC1 with regular cross entropy loss, in addition to other losses, including ranking loss. The calibration model, while it can include ranking loss, can be trained only on cross entropy loss, optimizing the UIR prediction, which is a function of representation of other co-displayed digital components or at least of the relation between the digital component trained for, DC1, and its co-displayed digital components.

FIGS. 4 to 7 illustrate various configuration alternatives. In FIG. 4, the system uses the top layer of both DC1 and DC2, both trained for both cross entropy and ranking, as calibration embeddings that are provided to a calibration model, with or without propagating the gradients into the primary models. Embeddings for DC1 may optionally be propagated into the calibration model (propagating them may be unnecessary given that the calibration model is already aware of the prediction for DC1). The calibration model can take the prediction score (logit) for DC1, and adjust a prediction using the information from the calibration model. The calibration model will learn the interaction between the representation of DC2 and that of DC1 and produce the calibrated prediction that takes advantage of this interaction. The interaction can be illustrated using an example containing two items, A and B, where A has much larger marginal engagement rate than B. However, when A is recommended together with B, engagement rates are reversed—that is, B has much larger marginal engagement rate than A. In this case, B should be recommended as ranked higher than A because both of them have been recommended together. The feature for B in A's model can be the embedding vector representing B. This vector can absorb the interaction information and can lead to a decreased engagement rate prediction for item A. Similarly, the embedding vector representing A in B's model will lead to an increased prediction of engagement rank for B in the presence of A. The calibration model learns from the training data to make this change to its prediction. Further, if a different vector is inserted in A's model, for some example C (that has no effect on A's engagement), the model will learn this information in training, and the embedding vector representing C will not have an effect on A's prediction, yet, for B's embeddings, the model will.

FIG. 5 illustrates a similar approach, but the input from the hidden embedding layer takes the form of a similarity score between the embeddings of DC1 and those of the co-displayed digital components. The approach illustrated in FIG. 6 is similar to that illustrated in FIG. 4, except that an embedding is trained with ranking loss, separately from the cross entropy loss on top of the primary model, and that separate embedding is used for the calibration model. This approach enhances the effect of the relation DC2 (and other digital components) imposed on DC1 in the calibrated prediction for DC1. FIG. 7 is similar to FIG. 6 similar, except that a similarity score between DC1 and its co-displayed digital components can be used as input to the calibration model instead of the actual embeddings.

FIG. 4 illustrates ranking calibration with top layer embeddings. Two (base) networks generate predictions for DC1 and DC2 using cross entropy and ranking losses. The top hidden layers are used as embedding inputs to a calibration model, which generates a final prediction for DC1. The prediction for DC1 also uses other co-recommended digital components DC3, etc., in a similar manner to its use of DC2. Gradients may optionally flow from the calibration model to the base networks. The calibration model may optionally include the hidden layer embeddings for DC1. The calibration operation can use both the original base prediction with the calibration signals to produce the final prediction. Similar additional inputs to the calibration model for DC1 can be applied from additional co-displayed digital components (DC3, DC4, etc.).

FIG. 5. Illustrates ranking calibration using top layer embeddings similarity scores. This calibration configuration for producing the prediction for DC1 is similar to the configuration shown in FIG. 4, except that the inputs to the calibration network can be a factorization of the embeddings for DC1 with those for DC2, or similarity scores between the two embedding vectors. Similar additional inputs to the calibration model for DC1 can be applied from additional co-displayed digital components (DC3, 4, etc.).

FIG. 6 illustrates ranking calibration with separate top layer embeddings. This calibration configuration for producing the prediction to DC1 is similar to the configuration shown in FIG. 4, except that separate embeddings trained by ranking loss are used as inputs to the calibration model. In this figure, ‘S’ 620 in a node denotes the Sigmoid (logistic) function transform, and ‘e’ 610 denotes a component of an embedding vector for DC1. Similar additional inputs to the calibration model for DC1 can be applied from additional co-displayed digital components (DC3, 4, etc.)

FIG. 7 illustrates ranking calibration with separate top layer embeddings similarity scores. This calibration configuration for producing the prediction to DC1 is similar to the configuration shown in FIG. 6, except that the inputs to the calibration network can be a factorization of the embeddings for DC1 with those for DC2, or similarity scores between the two embedding vectors. Similar additional inputs to the calibration model for DC1 can be applied from additional co-displayed digital components (DC3, 4, etc.).

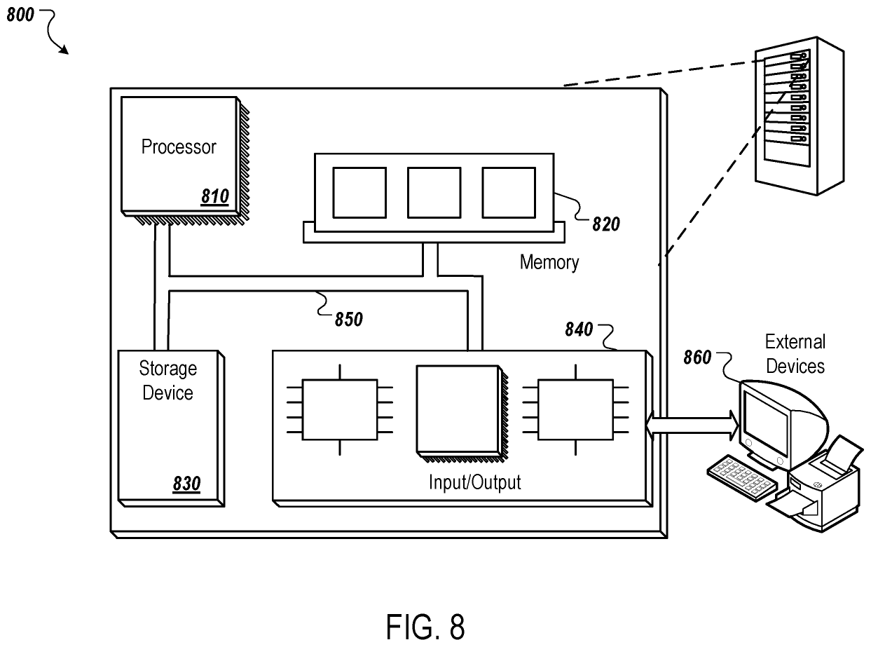

FIG. 8 is a block diagram of an example computer system 800 that can be used to perform operations described above. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In some implementations, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In some implementations, the memory 820 is a volatile memory unit. In another implementation, the memory 820 is a non-volatile memory unit.

The storage device 830 is capable of providing mass storage for the system 800. In some implementations, the storage device 830 is a computer-readable medium. In various different implementations, the storage device 830 can include, for example, a hard disk device, an optical disk device, a storage device that is shared over a network by multiple computing devices (e.g., a cloud storage device), or some other large capacity storage device.

The input/output device 840 provides input/output operations for the system 800. In some implementations, the input/output device 840 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 860, e.g., keyboard, printer and display devices. Other implementations, however, can also be used, such as mobile computing devices, mobile communication devices, set-top box television client devices, etc.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a storage medium, which may be a tangible non-transitory storage medium, for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative and disclosed in the form of numbered clauses:

Clause 1 is a method comprising:
receiving a digital component request;
providing, as input to a first machine learning model, first input data comprising feature values for features of each digital component in a set of digital component, wherein the first machine learning model is trained to output, for each digital component, a score that indicates a likelihood of a positive outcome for the digital component;
processing the first input data using the first machine learning model;
receiving, as a first output of the first machine learning model, respective scores for the digital components in the set of digital components;
providing, as input to a second machine learning model, second input data comprising feature values for features of each digital component in a subset of digital components selected based on the respective scores for the digital components in the set of digital components, wherein the second machine learning model is trained to output, a ranking of digital components based at least in part on feature values of features of digital components that will be provided together as recommendations;
processing the second input data using the second machine learning model;
receiving, as a second output of the second machine learning model, ranking of the digital components in the subset of digital components; and
providing at least one digital component in the subset of digital components based on the second ranking.

Clause 2 is the method of clause 1 wherein the second machine learning model is a same machine learning model as the first machine learning model.

Clause 3 is the method of clauses 1 to 2, wherein the second machine learning model is a different machine learning model from the first machine learning model and wherein the second machine learning model has been trained differently from the first machine learning model.

Clause 4 is the method of clause 3, wherein the second machine learning model, when processing identical input as the first machine learning model, executes fewer instructions to process the identical input than the first machine learning model.

Clause 5 is the method of clauses 1 to 4, wherein the second machine learning model is trained on training examples that include features of a set of co-recommended digital components that have been provided together as recommendations.

Clause 6 is the method of clause 5, further comprising:
selecting a first plurality of training examples from among the training examples that include co-recommended digital components;
modifying one or more features in the first plurality of training examples, wherein modifying a feature in the one or more features comprises removing information about co-recommended items; and
adding the first plurality of training examples to the training examples.

Clause 7 is the method of clause 6, where training the first machine learning model produces a gradient, the method further comprising propagating a gradient to a plurality of digital component embeddings, wherein the digital component embedding represent features of the co-recommend digital components.

Clause 8 is the method of clauses 1 to 7 wherein the first machine learning model processes an input that includes marginalized embeddings that represent a marginal contribution of a first feature over a contribution of a second feature and the second machine learning model processes an input that includes a plurality of digital component embeddings.

Clause 9 is the method of clause 8, wherein the first machine learning model is a neural network and the output of at least one layer of the neural network is used to train the second machine learning model.

Clause 10 is the method of clauses 1 to 9, wherein the second machine learning model is a neural network that includes a partial or full hidden layer that is configured to produce a third score associated with a first hidden digital component based on input associated with at least one second digital component.

Clause 11 is the method of clauses 10, wherein the third score is a direct loss, a ranking loss or a similarity score and is used as input to generate a prediction score of the second model.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
receiving a digital component request;
providing, as input to a first machine learning model, first input data comprising feature values for features of each digital component in a set of digital components, wherein the first machine learning model is trained to output, for each digital component, a score that indicates a likelihood of a positive outcome for the digital component;
processing the first input data using the first machine learning model;
receiving, as a first output of the first machine learning model, respective scores for the digital components in the set of digital components;
providing, as input to a second machine learning model, second input data comprising feature values for features of each digital component in a subset of digital components selected based on the respective scores for the digital components in the set of digital components, wherein the second machine learning model is trained to output, a ranking of digital components based at least in part on feature values of features of digital components that will be provided together as recommendations;
processing the second input data using the second machine learning model;
receiving, as a second output of the second machine learning model, ranking of the digital components in the subset of digital components; and
providing at least one digital component in the subset of digital components based on the second ranking.

2. The computer-implemented method of claim 1, wherein the second machine learning model is a same machine learning model as the first machine learning model.

3. The computer-implemented method of claim 1, wherein the second machine learning model is a different machine learning model from the first machine learning model and wherein the second machine learning model has been trained differently from the first machine learning model.

4. The computer-implemented method of claim 3, wherein the second machine learning model, when processing identical input as the first machine learning model, executes fewer instructions to process the identical input than the first machine learning model.

5. The computer-implemented method of claim 1, wherein the second machine learning model is trained on training examples that include features of a set of co-recommended digital components that have been provided together as recommendations.

6. The computer-implemented method of claim 5, further comprising:
selecting a first plurality of training examples from among the training examples that include co-recommended digital components;
modifying one or more features in the first plurality of training examples, wherein modifying a feature in the one or more features comprises removing information about co-recommended items; and
adding the first plurality of training examples to the training examples.

7. The computer-implemented method of claim 6, where training the first machine learning model produces a gradient, the method further comprising propagating a gradient to a plurality of digital component embeddings, wherein the digital component embedding represent features of the co-recommend digital components.

8. The computer-implemented method of claim 1, wherein the first machine learning model processes an input that includes marginalized embeddings that represent a marginal contribution of a first feature over a contribution of a second feature and the second machine learning model processes an input that includes a plurality of digital component embeddings.

9. The computer-implemented method of claim 8, wherein the first machine learning model is a neural network and the output of at least one layer of the neural network is used to train the second machine learning model.

10. The computer-implemented method of claim 1, wherein the second machine learning model is a neural network that includes a partial or full hidden layer that is configured to produce a third score associated with a first hidden digital component based on input associated with at least one second digital component.

11. The computer-implemented method of claim 10, wherein the third score is a direct loss, a ranking loss or a similarity score and is used as input to generate a prediction score of the second model.

12. The computer-implemented method of claim 1 wherein a positive outcome is indicative of a user interacting with or being likely to interact with the digital component when displayed on a device.

13. The computer-implemented method of claim 1 wherein the recommendations are recommendations of digital components to be displayed on a device.

14. A system comprising:
one or more computers; and
one or more storage devices storing instructions that when executed by the one or more computers cause the one or more computers to perform operations comprising:
receiving a digital component request;
providing, as input to a first machine learning model, first input data comprising feature values for features of each digital component in a set of digital components, wherein the first machine learning model is trained to output, for each digital component, a score that indicates a likelihood of a positive outcome for the digital component;
processing the first input data using the first machine learning model;
receiving, as a first output of the first machine learning model, respective scores for the digital components in the set of digital components;
providing, as input to a second machine learning model, second input data comprising feature values for features of each digital component in a subset of digital components selected based on the respective scores for the digital components in the set of digital components, wherein the second machine learning model is trained to output, a ranking of digital components based at least in part on feature values of features of digital components that will be provided together as recommendations;
processing the second input data using the second machine learning model;
receiving, as a second output of the second machine learning model, ranking of the digital components in the subset of digital components; and
providing at least one digital component in the subset of digital components based on the second ranking.

15. (canceled)

16. The system of claim 14, wherein the second machine learning model is a same machine learning model as the first machine learning model.

17. The system of claim 14, wherein the second machine learning model is a different machine learning model from the first machine learning model and wherein the second machine learning model has been trained differently from the first machine learning model.

18. The system of claim 17, wherein the second machine learning model, when processing identical input as the first machine learning model, executes fewer instructions to process the identical input than the first machine learning model.

19. The system of claim 14, wherein the second machine learning model is trained on training examples that include features of a set of co-recommended digital components that have been provided together as recommendations.

20. The system of claim 14, wherein the operations comprise:
selecting a first plurality of training examples from among the training examples that include co-recommended digital components;
modifying one or more features in the first plurality of training examples, wherein modifying a feature in the one or more features comprises removing information about co-recommended items; and
adding the first plurality of training examples to the training examples.

21. One or more non-transitory computer-readable storage media storing instructions that when executed by one or more computers cause the one or more computers to perform operations comprising:
receiving a digital component request;
providing, as input to a first machine learning model, first input data comprising feature values for features of each digital component in a set of digital components, wherein the first machine learning model is trained to output, for each digital component, a score that indicates a likelihood of a positive outcome for the digital component;
processing the first input data using the first machine learning model;
receiving, as a first output of the first machine learning model, respective scores for the digital components in the set of digital components;
providing, as input to a second machine learning model, second input data comprising feature values for features of each digital component in a subset of digital components selected based on the respective scores for the digital components in the set of digital components, wherein the second machine learning model is trained to output, a ranking of digital components based at least in part on feature values of features of digital components that will be provided together as recommendations;
processing the second input data using the second machine learning model;
receiving, as a second output of the second machine learning model, ranking of the digital components in the subset of digital components; and
providing at least one digital component in the subset of digital components based on the second ranking.
